(19) United States
(12) Patent Application Publication
(10) Pub. No.: US 2004/0055435 A1
(43) Pub. Date: Mar. 25, 2004

(54) Rotary cutting device and printer incorporating the same

(75) Inventors: Katsumune Hayashi, Shizuoka-ken (JP); Hiroyuki Koyama, Shizuoka-ken (JP); Kouichi Yamada, Shizuoka-ken (JP)

Correspondence Address: PILLSBURY WINTHROP, LLP, P.O. BOX 10500, MCLEAN, VA, 22102, US

(73) Assignee: Toshiba TEC Kabushiki Kaisha, Tokyo (JP)

(21) Appl. No.: 10/659,387

(22) Filed: Sep. 11, 2003

(30) Foreign Application Priority Data
Sep. 20, 2002 (JP) 2002-275754

(51) Int. Cl. B23D 35/00

(52) U.S. Cl. 83/341; 83/673; 83/694; 83/349

(57) ABSTRACT

A recording paper is cut such that the movable-blade holding member 17 of a resin holding the movable blade 15, which is rotatably provided in a supporting section, is driven to rotate by a drive section so as to shift a cutting position formed between the cutting edge 14b of the stationary blade 14 and the cutting edge 15a of the movable blade 15. Thereby formation of a support axis in the movable blade 15 is not needed, as needed in conventional movable blades. In addition, because the movable-blade holding member 17 folding the movable blade 15 is of a resin, it can be die-formed.

### BACKGROUND OF THE INVENTION

1. Field of the Invention

The present invention relates to a rotary cutting device for cutting a recording paper and a printer incorporating the rotary cutting device.

2. Description of Related Art

In general, many receipt printers and facsimile machines using a lengthy recording paper such as a receipt paper are provided with a cutting device for cutting a printed paper into a sheet of an appropriate length downstream from a printing section in a paper advancing direction. One example of such a cutting device is a rotary cutting device 103, as shown in FIG. 9, which is designed to cut a cutting object (for example, a receipt paper) positioned between cutting edges 101a and 102a of blades by rotating a platy movable blade 101 having a length across a full width of the recording paper in respect to a stationary blade 102 and making the blades to engage with each other as in a pair of scissors. Such a rotary cutting device 103 provides reliable cutting despite of its simple structure.

The movable blade 101 of such rotary cutting device 103 includes the cutting edge 101a at one edge of a base 101b and supporting axes 101c at both ends of the base 101b, and is formed by cutting one piece of metal cutting material. The movable blade 101 is rotatably supported by a frame 104 on the supporting axes 101c, being connected to a drive section, not shown, and is provided to rotate by a driving power from the drive section.

However, cost of such rotary cutting device 103 is raised due to necessity of cutting of the movable blade 101 having the supporting axes 101c. Also, in mass-production of the rotary cutting device 103, because the movable blade 101 must be individually processed for cutting, there is expected little cost margin in mass-production of the rotary cutting device 103 despite of a large amount of production of the movable blade 101.

### SUMMARY OF THE INVENTION

An object of the present invention is to reduce a cost of a rotary cutting device. This object can be accomplished by providing a rotary cutting device comprising a stationary blade having a cutting edge, a movable blade having a cutting edge, a movable-blade holding section of a resin that holds the movable blade, the cutting edge of the stationary blade and the cutting edge of the movable blade being positioned at a slight angle in respect to their parallel arrangement so as for the two cutting edges to engage each other, a supporting section for rotatably supporting the movable-blade holding section enabling the engaging position of the cutting edges to move as the movable-blade holding section rotates, and a driving section for driving to rotate the movable-blade holding section supported by the supporting section.

Thus, a cutting object, which is interposed between the cutting edge of the stationary blade and the cutting edge of the movable blade that are positioned at a slight angle in respect to their parallel arrangement, is cut as the engaging position of the movable blade cutting edge and stationary blade cutting edge moves in line with rotation of the movable blade. Because the movable blade is held by the movable-blade holding section, it needs no longer to form supporting axes as provided in conventional movable blades. Besides, because the movable-blade holding section for holding the movable blade is made of a resin, it can be die-formed.

### BRIEF DESCRIPTION OF THE DRAWINGS

FIG. 1 is a longitudinal cross sectional side view that generally displays a receipt printer incorporating a rotary cutting device as an embodiment according to the present invention.

FIG. 2 is a general prospective front view of a structure of the rotary cutting device.

FIG. 3 is a general prospective rear view of the movable-blade holding member in the rotary cutting device and the movable blade that is dismounted from this movable-blade holding member.

FIG. 4 is a general plan view of the movable-blade holding member in a state that the movable blade is mounted in the rotary cutting device.

FIG. 5 is a side view that generally displays a structure of a drive force transmitting mechanism in the rotary cutting device

FIG. 6 is a longitudinal side view that generally displays the receipt printer in a state that the upper unit and lower unit are separated from each other.

FIG. 7 is a perspective view that generally displays the receipt printer in a state that the upper unit and lower unit are assembled.

FIG. 8 is a longitudinal sectional side view that shows a structure in which a thermal printer and a hook member are mounted.

FIG. 9 is a perspective view of a conventional rotary cutting device.

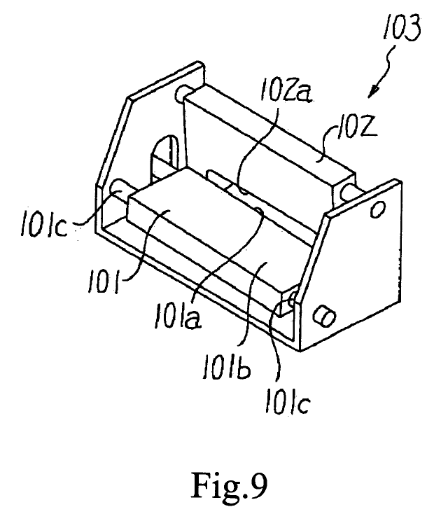

### DETAILED DESCRIPTION OF A PREFERRED EMBODIMENT OF THE INVENTION

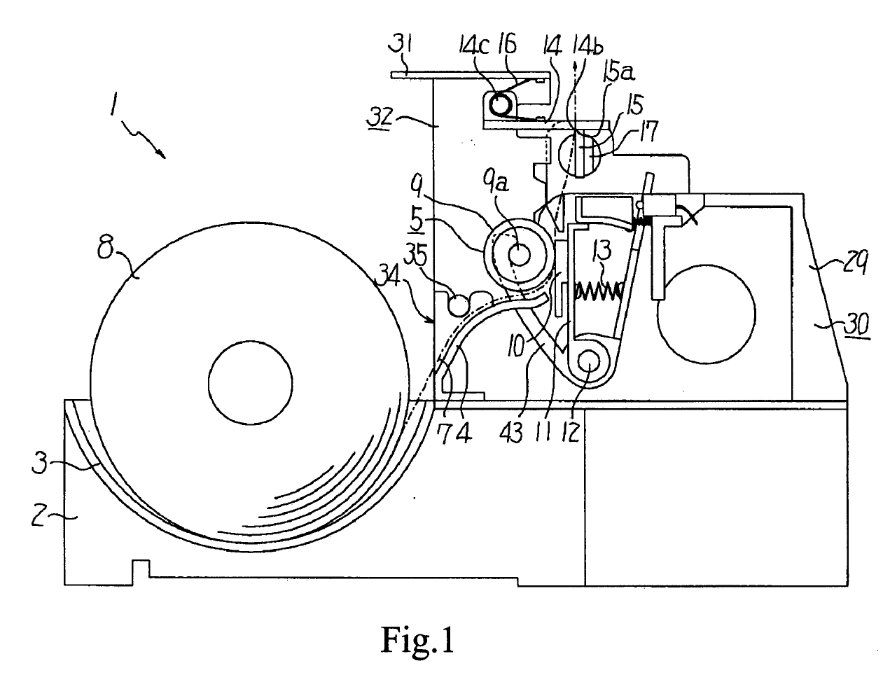

An embodiment according to the present invention will be described in reference to FIGS. 1 through 8. This embodiment is an example of a receipt printer to which the present invention is applied. This printer is provided with a rotary cutting device as a cutter device and is incorporated into a POS terminal or ECR.

FIG. 1 is a side view of a longitudinal cross section that generally displays a receipt printer of the present embodiment. As shown in FIG. 1, the receipt printer is composed of a main frame 2, paper compartment 3, paper guide 4, printing section 5, rotary cutting device 6, and others. In this receipt printer 1, the paper travel path 7 is formed through paper compartment 3, printing section 5, and rotary cutting device 6. The paper compartment 3 having a hyperbolic bottom contains a lengthy rolled recording paper 8 as a cutting object. The paper guide 4, which is formed en route from a leading edge of the paper compartment 3 to the printing section 5, supports the recording paper 8 on the surface of the paper.

The printing section 5 is composed of a platen 9 and a thermal head 10 as a recording head facing the platen 9. The platen 9 is driven to rotate by a motor, not shown, intervened by lined gears, not shown. The thermal head 10 is mounted on a flat head holding member 11. This head holding member 11 is provided so as to freely pivot on a fulcrum 12 towards or apart from the platen 9, and is biased towards the platen 9 by a force of a coil spring 13 that is provided between the head holding member 11 and a hooking member 43. The coil spring 13 serves as a compression spring, which will be described later. The thermal head 10 thereby abuts to the platen 9. The printing part 5 performs printing by the thermal head 10 on a recording paper 8 interposed between the platen 9 and the thermal head 10. The recording paper 8 is conveyed along the paper travel path 7 by the platen 9 driven to rotate by the motor. The printing section 5 functions also as a paper transport section for transporting the recording paper 8.

The rotary cutting device 6, which is provided downstream from the printing section 5 in a paper advancing direction, is structured in combination of the stationary blade 14 and the movable blade 15, both of which are formed nearly flat.

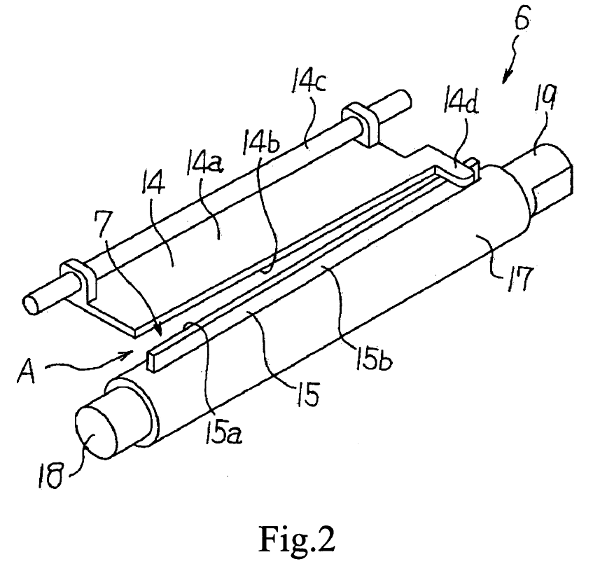

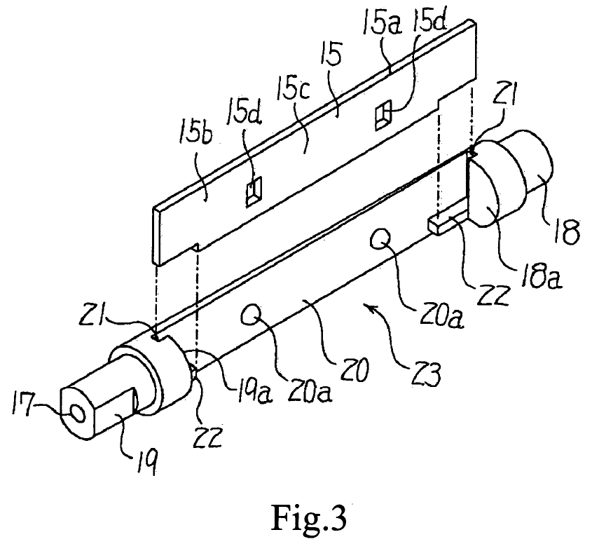

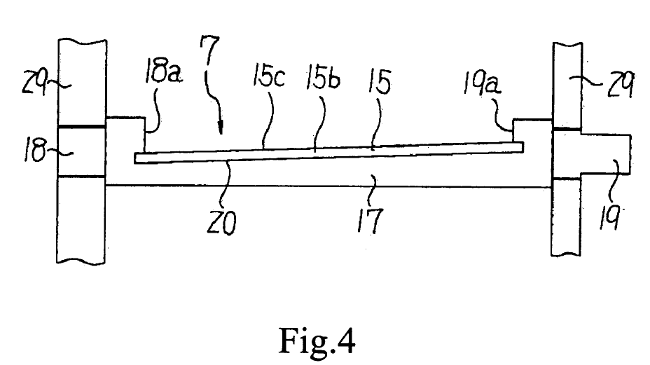

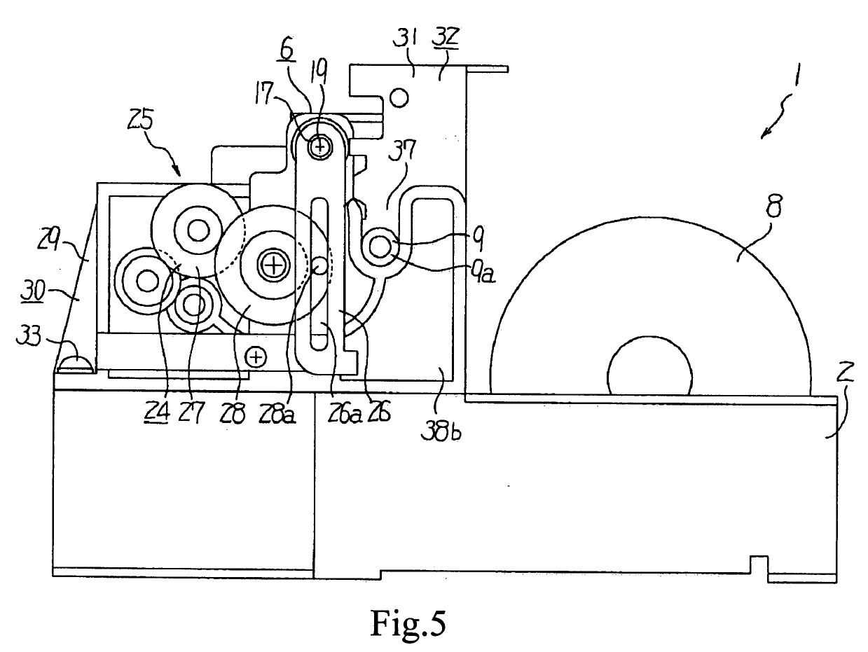

FIG. 2 is a perspective view that generally shows a structure of the rotary cutting device 6 from the front. FIG. 3 is a perspective view that generally shows from rear the movable-blade holding member and the movable blade 15 dismounted from this movable-blade holding member in the rotary cutting device 6. FIG. 4 is a plane view that generally shows the movable-blade holding member in a state that the movable blade 15 is mounted back in the rotary cutting device 6. FIG. 5 is a side view that generally shows a structure of the drive force transmitting mechanism in the rotary cutting device 6.

As shown in FIG. 2, in the stationary blade 14, one edge of the nearly flat body 14a forms the cutting edge 14b. On the edge opposite to the cutting edge 14b in the shorter direction of the stationary blade 14, a support axis 14c is provided. This support axis is movably mounted to an upper unit frame 31, which will be described later. Between the stationary blade 14 and the upper unit frame 31 a spring 16 (refer to FIG. 1) is provided, by which the stationary blade 14 is biased towards the movable blade 15. Also, in the stationary blade 14, a guiding part 14d is formed for guiding the cutting edge 15a to a position where it engages with the cutting edge 14b of the stationary blade 14. To be more specific, this guiding part 14d is formed continuing from the cutting edge 14b and protruding on the outskirts of the cutting edge 14b. This stationary blade 14 is held nearly on the level in a state that the stationary blade 14 and the movable blade 15 are engaged each other, as shown in FIG. 1.

On the other hand, on the nearly flat base 15b of the movable blade 15 is formed a surface 15c, which provides the paper travel path 7. At an edge of the surface 15c is formed the cutting edge 15a of the movable blade 15. This movable blade 15 can be readily mounted or dismounted to/from the movable-blade holding member 17 as a movable-blade holding section, as shown in FIGS. 3 and 4.

The movable-blade holding member 17 is of a resilient resin, formed in a rod, and positioned so that its axis parallels with an axis of the platen 9. At the both ends of the movable-blade holding member 17 are formed support axes 18, 19, which are rotatably supported by a lower unit frame 29, which will be described later. In the middle of the movable-blade holding member 17 between the both support axes 17 and 18, there is provided a plane 20 for holding the movable blade 15, whose cross section forms a near semicircle. At both ends of this plane 20 inside the support axes 17 and 18, there are formed grooves, respectively, to which the ends of the movable blade 15 can slidably engage. At bottom of each groove 21, position-determining parts 22 for supporting and determining positions of low end of the movable blade 15, which is inserted into the grooves 21, are provided.

Also, as shown in FIG. 4, the grooves 21 of the movable-blade holding member 17 are formed so that the movable blade 15 inserted is slightly inclined from a line parallel with the axis of the movable-blade holding member 17. Accordingly, the cutting edge 14b of the stationary blade 14 and the cutting edge 15a of the movable blade 15 are disposed as slightly inclined from the imaginary parallel line. Therefore, a cutting object passage A between the cutting edge 14b of the stationary blade 14 and the cutting edge 15a of the movable blade 15 is provided in a V-shape, as indicated in FIG. 2. This cutting object passage A forms a part of the paper travel path 7. In a state that the stationary blade 14 and the movable blade 15 are engaged with each other, this movable blade 15 is held vertically, as shown in FIG. 1.

In the base 15b of the movable blade 15, there are provided two apertures 15d as engaging parts, as shown in FIG. 3. On the other hand, on the plane 20 of the movable-blade holding member 17, two hemicycle-protrusions 20a that engage with the above apertures are formed. To make the movable blade 15 to engage with the grooves 21, the movable blade 15 is moved so that the cutting edge 15a of the movable blade 15 and the opposite lower edge slide into the grooves. As the movable-blade holding member 17 having a resilient property bends, the protrusions 20a are allowed to engage into the apertures 15d. The movable blade 15 now engaged in the grooves 21 are in a state of being interposed between the resilient grooves 21. By these engagements, movement of the movable blade 15 is restrained, and so the movable blade 15 is secured into the grooves 21.

In this state, the cutting edge 15a of the movable blade 15 protrudes in a direction normal to the periphery of the movable-blade holding member 17, while the base 15b of the movable blade 15 reaches near the periphery of the movable-blade holding member 17 opposite to the cutting edge 15a of the movable blade 15. That is, the movable blade 15 has a length nearly the same as the diameter of the movable-blade holding member 17. Thus, the movable-blade holding member 17 is reinforced by the movable blade 15, as it is fixed thereto, with the whole strength, even though the movable-blade holding member 17 is made of a resin.

To detach the movable blade 15 from the grooves 21 of the movable-blade holding member 17, the movable blade 15 is withdrawn from the grooves 21, so that the movable-blade holding member 17 is bent so as to release the engagement of the protrusions 20a and the apertures 15d, and the movable blade 15 comes off. Herein, the apertures 15d and the protrusions 20a constitute a securing section 23.

As shown in FIGS. 3 and 4, inside both fulcrum shafts 18 and 19 of the movable-blade holding member 17 that detachably holds the movable blade 15 in this manner, paper guides 18a and 19a, which face to each other interposing the plane 20, are formed. An interval between these paper guide surfaces 18a and 19a is set to be almost the same as a width of the recording paper 8 perpendicular to the paper directing direction. The paper guide surfaces 18a and 19a serve to position ends of the recording paper 8, in the paper advancing direction, which is conveyed along the paper traveling path 7. The paper traveling path 7 is formed by one surface 15c of the movable blade 15 now fixed to the movable-blade holding member 17.

The fulcrum shaft 19 of the movable blade 15 as such is coupled to the driving force transmitting mechanism 24 (refer to FIG. 5) that transmits a drive force of a motor (not shown). Herein, this motor and the driving force transmitting mechanism 24 constitute a drive section 25.

Now, the drive force transmitting mechanism 24 of a drive section 25 will be briefly explained in reference to FIG. 5. The drive force transmitting mechanism 24 is composed of a cutter arm 26 that is coupled to the fulcrum shaft 19 of the movable blade 15 and swung with and on this fulcrum shaft 19, a train of gears 27 that is mounted to the lower unit frame 29 and coupled to a motor, and a drive crank 28 that is rotatably mounted to the lower unit frame 29. The drive crank 28 constitutes a cum mechanism along with the cutter arm 26 being connected to the gear train 27. In the cutter arm 26, a vertically long slot 26a is formed, into which an eccentric pin 28a of the drive crank 28 is engaged. Accordingly, the eccentric pin 28a of the drive crank 28 comes to move within the slot 26a of the cutter arm 26 in line with rotation of the drive crank 28, which rotates by a drive force of the motor transmitted via the gear train 27. By such a motion of this eccentric pin 28a on the drive crank 28 within the slot 26a of the cutter arm 26, the cutter arm 26 can be swung on this fulcrum shaft 19.

As the cutter arm 26 swings in this manner, the movable blade 15 is made to rotate on the fulcrum shaft 19. In line with this rotation, the movable blade 15 presses itself onto the guiding part 14d of the stationary blade 14. In this instance, the stationary blade 14 produces a reactive force in a direction opposite to the rotating direction by the restoring force of the spring 16 connecting the stationary blade 14 and the upper unit frame 31. Namely, because the cutting edge 14b of the stationary blade 14 and the cutting edge 15a of the movable blade 15 are positioned at a slightly angle in respect to the assumed parallel line, the respective cutting edges 14b and 15a are to engage each other like a pair of scissors. As the cutting object passage A in a V-shape is gradually moved to become narrowed down by rotation of the movable blade 15 and the reactive force of the stationary blade 14, that is, by shifting an engaging position between the cutting edge 14b of the stationary blade 14 and the cutting edge 15a of the movable blade 15, the rotary cutting device 6 cuts a recording paper as a cutting object in the cutting object passage A, which is a part of the paper traveling passage 7.

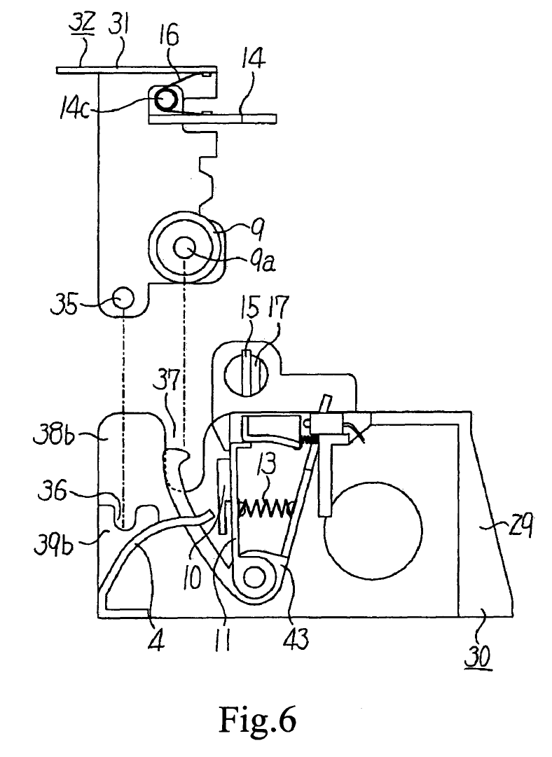

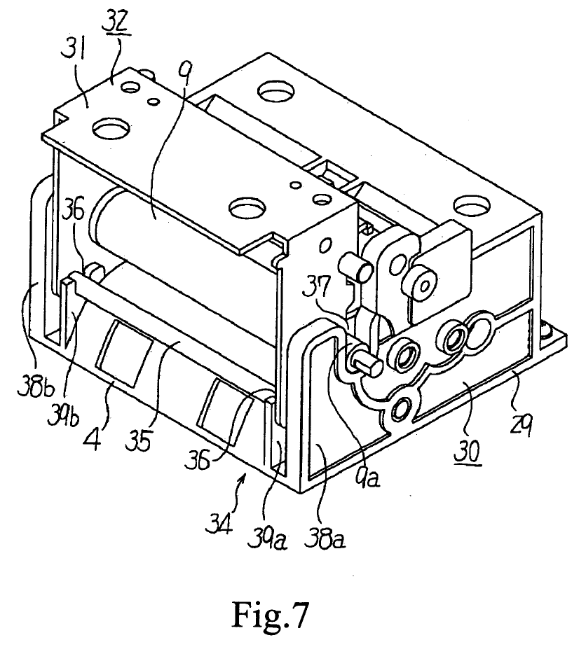

FIG. 6 is a side view of the longitudinal section that generally shows the receipt printer 1 in which the upper unit and the lower unit are separated. FIG. 7 is a perspective view that generally shows the receipt printer 1 in which the upper unit and the lower unit are united.

As shown in FIGS. 1, 5, 6, and 7, the paper guide 4, thermal head 10, movable blade 15, and drive force transmitting mechanism 24, described above, are provided in the lower unit frame 29 as a supporting section. These components constitute the lower unit 30. On the other hand, the platen 9 and stationary blade 14 are provided in the upper unit frame 31 of a horseshoe shape, which is provided independently of the lower unit frame 29. They constitute the upper unit 32. The paper compartment 3 is provided in a main frame 2. The motor for driving the movable blade 15 and the motor for driving the platen 9 are mounted on the lower unit frame 29.

The lower unit 30 is screwed with screws 33 on the main frame 2 so as to be fixed and detached to/from the main frame 2. The upper unit 32 is mounted to the lower unit 30 so as to be fixed and detached to/from it by a connecting mechanism 34.

The connecting mechanism 34 comprises a connection rod 35 and platen 9 installed in the upper unit frame 31 of the upper unit 32, cuts 36 that are formed in the lower unit frame 29 of the lower unit 30 to allow the connection rod 35 to engage therein, and cuts 37 that are formed in the lower unit frame 29 of the lower unit 30 to allow the both fulcrum shafts 9a to engage therein.

The connection rod 35 is provided upstream from the platen 9 in the paper advancing direction so that its axis parallels an axis of the platen 9 whose axis is oriented in a paper width direction. The cuts 36 are vertically formed in both sidewalls 38a and 38b of the lower unit frame 29 with their upper ends open. The cuts 37 are vertically formed in a pair of sidewalls 39a and 39b, which stand inside sidewalls 38a and 38b of the lower unit frame 29, with their upper ends open. As the connection rod 35 and the fulcrum shafts 9a fit in the cuts 36 and 37, respectively, position of the upper unit 32 is determined in respect to the lower unit 30, and the upper unit 32 and the lower unit 30 are coupled together. In this state, the upper unit 32 is fixed to the lower unit 30 so as to prevent the upper unit 32 from rotating apart from the lower unit 30. Under this connection, the platen 9 faces the thermal head 10, and the movable blade 15 and the stationary blade 14 are positioned so as to able to cut the recording paper 8. An interval between the pair of internal walls 39a and 39b is provided to be narrower than that between the both sidewalls 40a and 40b of the upper unit frame 31. This setting constitutes a guide in sideway for positioning the upper unit 32 in respect to the lower unit 30, when the pair of internal walls 39a and 39b is inserted between the both sidewalls 40a and 40b of the upper unit frame 31 in jointing the upper unit 32 to the lower unit 30.

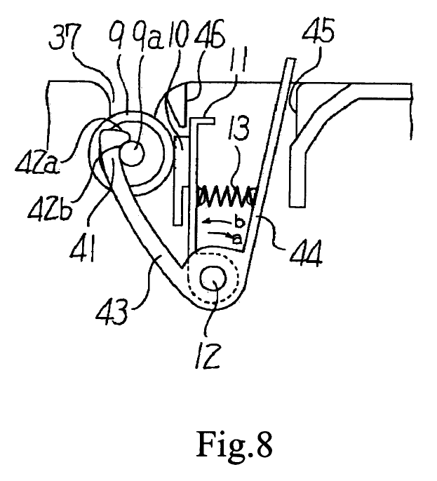

Also, as shown in FIG. 8, the lower unit 30 is provided with hooking members 43, in which two hooking parts 41 for engaging and disengaging the both fulcrum shafts 9a of the platen 9 now fitted in the cuts 37 are formed. Each of these hooking members 43 comprises the hooking part 41 and a plane part 44, which is formed integral with the hooking part 41. The members 43 are provided so that the hooking parts 41 can freely rotate on a center of the fulcrums 12 in directions of engaging and disengaging the both fulcrum shafts 9a of the platen 9. Also, the members 43 are biased by the coil spring 13, which is provided between the head holding member 11 and the members 43, in the direction (as indicated by the arrow a in FIG. 8) of engaging the both fulcrum shafts 9a of the platen 9.

In the hooking parts 41, there are formed slant parts 42a for escaping interference by the fulcrum shafts 9a associating with rotation of the hooking members 43 while the hooking parts 41 abut to the fulcrum shafts 9a of the platen 9 when mounting the upper unit 32 to the lower unit 30, and slant parts 42b for escaping interference by the fulcrum shafts 9a associating with rotation of the hooking members 43 while the hooking parts 41 abut the fulcrum shafts 9a of the platen 9 when dismounting the upper unit 32 from the lower unit 30. When the upper unit 32 is made to conjoin the lower unit 30, the interference by the hooking members 43 to the fulcrum shafts 9a of the platen 9 is escaped against the biasing force of the coil spring 13 by rotation of the hooking members 43, so that the hooking parts 41 eventually engage the fulcrum shafts 9a of the platen 9 and the upper unit 32 is locked against its upward movement from the lower unit 30. To the contrary, when the upper unit 32 is made to separate from the lower unit 30, the interference by the hooking members 43 to the fulcrum shafts 9a of the platen 9 is escaped against the biasing force of the coil spring 13 by rotation of the hooking members 43, so that engagement between the hooking parts 41 and the fulcrum shafts 9a of the platen 9 is eventually released, enabling the upper unit 32 to be removed from the lower unit 30.

In a state that the upper unit 32 is not conjoined with the lower unit 30, the hooking members 43 that is biased by the coil spring 13 and the head holding member 11 are so positioned, abutting to positioning surfaces 45 and 46, respectively, which are formed in the lower unit frame 29.

To load the recording paper 8 in the receipt printer 1 in this state, the upper unit 32 is dismounted. To be more specific, the upper unit 32 is pulled upward so as to relieve locking of the platen 9 by the hooking members 43 and release coupling of the connecting mechanism 34. Then, the upper unit 32 can be detached from the lower unit 30. Alternately, locking of the platen 9 by the hooking members 43 can be also released by rotating the hooking members 43 in the lock-releasing direction (as indicated by the arrow b in FIG. 8). In this state, the recording paper 8 is loaded into the paper compartment 3. Then, the recording paper 8 is pulled downstream from the movable blade 15 in the paper advancing direction, and the upper unit 32 is pushed down towards the lower unit 30 so that the connection rod 35 and the platen 9 in the upper unit 32 fit into cuts 36 and 37, respectively, and the upper unit 32 and the lower unit 30 are coupled to each other. In this instance, the platen 9 is locked by the hooking members 43. As the upper unit 32 and the lower unit 30 are coupled together in such a manner, the recording paper 8 is in a path between the connection rod 35 and the paper guide 4, between the thermal head 10 and the platen 9, and between the stationary blade 14 and the movable blade 15. Thus, in the present embodiment, because the upper unit 32 is provided so as to be readily mounted and dismounted to/from the lower unit 30, setting of the recording paper 8 in the receipt printer 1 can be easily made.

In printing, the recording paper 8 contained and supported in the paper compartment 3 is conveyed through the paper travel path 7 towards the printing part 5 and the rotary cutting device 6, driven by the platen 9, and a given receipt information can be sequentially printed on it by the thermal head 10. When printing is finished, the recording paper 8 is cut at a tail of the printed part by driving the movable blade 15 in the cutting device. The cut recording paper 8 is issued as a receipt.

Because a force that the movable blade 15 receives from the stationary blade 14 during this cutting operation effects in the direction where the movable blade 15 is caused to engage further into the grooves 21 in the movable-blade holding member 17, it can be prevented that the movable blade 15 runs out of the grooves 21.

In the rotary cutting device 6 according to this embodiment, since the movable blade 15 is held by the movable-blade holding member 17, to form support axes in the movable blade 15 is no longer needed, as needed in conventional movable blades. Also, because the movable-blade holding member 17 supporting the movable blade 15 is of a resin, it can be manufactured by die-forming. Thus, cost of the rotary cutting device 6 can be reduced, comparing to conventional rotary cutting devices whose movable blade having a supporting axis is formed through cutting process. Particularly, since die-forming the movable blade 15 of a resin yields a cost merit in mass-production, the cost of the rotary cutting device 6 can be further reduced.

When lifetime of the movable blade 15 is reached, the movable blade 15 can be changed by removing the movable blade 15 that reached the lifetime from the movable-blade holding member 17 and installing a new one to the movable-blade holding member 17.

In conventional rotary cutting device, when the movable blade 15 reaches its lifetime and the movable blade needs to be replaced, a member that supports the movable blade and a member that imparts a drive force to the movable blade need to be disassembled. Whereas, in the present embodiment, because the movable-blade holding member 17 as a movable-blade holding section holds the movable blade 15 such that the movable blade 15 can be readily mounted and dismounted thereto/therefrom by the grooves that allow at least one edge side and the other edge side of the movable blade 15 to engage therein, such disassembling is no longer needed. Thus, replacement of the movable blade 15 can be readily made. Herein, a fear may be assumed when changing the movable blade 15, since one holds a side of the cutting edge 15a of the movable blade 15 by the hand. However, even if the hand contacts the cutting edge, it is safe because there should be no danger of injuring the hand. Also, deformation of the movable-blade holding member 17 during the cutting operation can be prevented, since the movable-blade holding member 17 has been reinforced with the movable blade 15 such that the movable blade 15 engages into the grooves 21 of the movable-blade holding member 17 of a resin.

Furthermore, in the rotary cutting device 6 according to this embodiment, as the grooves 21 is provided such that the movable blade 15 is oriented at a slight angle in respect to a line parallel with an axis of the movable-blade holding member 17 as a movable-lade supporting section, the cutting edge 15a of the movable blade 15 and the cutting edge 14b of the stationary blade 14 are to become arranged at a slight angle in respect to the assumed parallel line according to the position of the groove 21. Therefore, the axis of the movable-blade holding member 17 needs not to be positioned at a slant in respect to a paper width direction (direction of the axis of the platen 9), as needed so in conventional cutters. Instead, the axis of the movable-blade holding member 17 can now be provided in parallel with the width direction of the recording paper 8. This facilitates to manufacture the movable-blade holding member 17 and the mounting part of the member 17.

Still furthermore, the rotary cutting device 6 of this embodiment is structured such that: the movable-blade holding member 17 as a movable-blade supporting section is resilient; either one of the movable-blade holding member 17 or the movable blade 15 is provided with the protrusions 20a, and the other of either the movable-blade holding member 17 or the movable blade 15 is provided with the apertures 15d as an engaging part; and there is provided the securing section 23 for securing in the grooves 21 the movable blade 15, which is engaged in the grooves 21, by engaging the protrusions 20a into the apertures 15d while the movable-blade holding member 17 being bent along with movement to engage the movable blade 15 into the grooves 21. This structure can prevent the movable blade 15 engaged in the grooves 21 of the movable-blade holding member 17 from being coming off from the grooves 21.

What is claimed is:

1. A rotary cutting device, comprising:
a stationary blade having a cutting edge;
a movable blade having a cutting edge;
a movable-blade holding section of a resin for holding said movable blade;
a supporting section for rotatably supporting said movable-blade holding section, wherein the cutting edge of said stationary blade and the cutting edge of said movable blade are positioned at a slight angle in respect to parallel lines thereof so as for the two cutting edges to engage each other, and wherein the engaging position of the cutting edges moves by rotation of said movable-blade holding section; and
a drive section for rotating said movable-blade holding section that is held by said supporting section.

2. A device according to claim 1, wherein said movable-blade holding section forms grooves and detachably holds said movable blade by the grooves in which at least one edge side and the other edge side of said movable blade engage.

3. A device according to claim 2, wherein, in a state that said movable blade is held in said movable-blade holding section, said movable blade has a length nearly equivalent to a diameter of said movable-blade holding section, and the cutting edge of said movable blade protrudes from said movable blade support section.

4. A device according to claim 3, wherein the grooves determines a position of said movable blade such that said movable blade is disposed at an angle in respect to a line parallel with an axis of said movable-blade holding section.

5. A device according to claim 3, wherein said movable-blade holding section is resilient, either one of the movable-blade holding section or the movable blade forming a protrusion and the other of either the movable-blade holding section or the movable blade forming an engaging part, and said movable-blade holding section comprises a securing section for securing the movable blade as engaged in the grooves by engaging the protrusion into the engaging part as the movable-blade holding section is bent in line with movement to engage the movable blade into the grooves 21.

6. A device according to claim 4, wherein said movable-blade holding section is resilient, either one of the movable-blade holding section or the movable blade forming a protrusion and the other of either the movable-blade holding section or the movable blade forming an engaging part, and said movable-blade holding section comprises a securing section for securing the movable blade as engaged in the grooves by engaging the protrusion into the engaging part as the movable-blade holding section is bent in line with movement to engage the movable blade into the grooves 21.

7. A printer comprising:
a paper transport section for transporting a recording paper;
a printer section for printing on the recording paper transported by said paper transport section; and
a rotary cutting device for cutting the recording paper according to any one of claims 1 through 6, rotary cutting device being provided downstream from the said printing section in the paper advancing direction.
